(19) United States
(12) Patent Application Publication
(10) Pub. No.: US 2026/0242167 A1
(43) Pub. Date: Aug. 20, 2026

(54) PRECISION POSITIONING MECHANISM FOR SHEET MATERIALS, PRINTING DEVICE, AND PRINTING PROCESS

(71) Applicant: Polytech(Shenzhen)Inc., Shenzhen (CN)

(72) Inventors: Hongzhi ZHANG, Shenzhen (CN); Lan AN, Shenzhen (CN)

(21) Appl. No.: 19/222,023

(22) Filed: May 29, 2025

(30) Foreign Application Priority Data
Feb. 14, 2025 (CN) 202520242119.3
May 22, 2025 (CN) 202510672393.9

(51) Int. Cl. B65H 9/10; B65H 5/22

(52) U.S. Cl. CPC B65H 9/105; B65H 5/222; B65H 5/228; B65H 9/108

(57) ABSTRACT

A precision positioning mechanism for sheet materials includes a platform, positioning rods, a blowing component and a suction component. The platform includes a positioning plate, and positioning plate defines blowing holes and suction holes. The positioning rods are located on two adjacent edges of the positioning plate and protrude from the positioning plate, and each of the blowing holes is inclined with respect to a thickness direction of the positioning plate and is inclined facing towards an intersection point of the two adjacent edges of the positioning plate where the positioning rods are located. An air outlet of the blowing component is connected to the blowing holes to blow air into the blowing holes, and an air inlet of the suction component is connected to the suction holes to draw air. The precision positioning mechanism has advantages including accurate positioning, a simpler structure, and a lower cost.

### CROSS-REFERENCE TO RELATED APPLICATION

This application claims priority to Chinese Patent Application No. 202520242119.3, filed on February 14, 2025, which is herein incorporated by reference in its entirety.

This application claims priority to Chinese Patent Application No. 202510672393.9, filed on May 22, 2025, which is herein incorporated by reference in its entirety.

### TECHNICAL FIELD

The disclosure relates to the field of sheet material positioning technologies, and more particularly to a precision positioning mechanism for sheet materials, a printing device, and a printing process.

### BACKGROUND

During processes such as printing, cutting, and gluing etc., it is necessary to accurately position sheet materials, including but not limited to paper, plastic sheets, wood panels, and metal sheets.

In the related art, positioning methods include charge-coupled device (CCD) positioning, fiber optic detection head positioning, and laser positioning. Although these positioning methods can achieve precise positioning, they all have problems of high cost and stringent structural requirements. Therefore, the disclosure provides a precision positioning mechanism for sheet materials, a printing device, and a printing process.

A purpose of the disclosure is to provide a precision positioning mechanism for sheet materials, a printing device, and a printing process, thereby to solve problems of high cost and stringent structural requirements in sheet material positioning methods in the related art.

To achieve the above purpose, the disclosure provides the following technical solutions.

In a first aspect, the disclosure provides a precision positioning mechanism for sheet materials.

The precision positioning mechanism includes a platform, positioning rods, a blowing component and a suction component. The platform includes a positioning plate, and the positioning plate defines multiple blowing holes and multiple suction holes. The positioning rods are securely affixed to two adjacent edges of the positioning plate and protrude from the positioning plate at certain occasion, and each of the multiple blowing holes is inclined with respect to a thickness direction of the positioning plate and is inclined facing towards an intersection point of the two adjacent edges of the positioning plate where the positioning rods are located. An air outlet of the blowing component is connected to the multiple blowing holes to blow air into the multiple blowing holes, and an air inlet of the suction component is connected to the multiple suction holes to draw air through the multiple suction holes.

In an embodiment, the platform further includes a base plate which is right under the positioning plate, and connecting supports. The positioning plate has a flat-plate structure, and the base plate is arranged parallel to the positioning plate. The positioning plate is connected to the base plate through the connecting supports.

In an embodiment, the multiple blowing holes and the multiple suction holes are disposed in a row-and-column array.

In an embodiment, the blowing component has a fan structure and is fixedly connected between the positioning plate and the base plate. A surface of the positioning plate facing towards the base plate defines a square-shaped air collection groove (i.e., an air collection groove is square-shaped). Multiple blowing component are configured to blow the air toward the air collection groove and subsequently through the blowing holes.

In an embodiment, the positioning plate defines multiple air conducting holes, the multiple air conducting holes are blind holes, the multiple suction holes are connected to the multiple air conducting holes, and the air inlet of the suction component is connected to ends of the multiple air conducting holes.

In an embodiment, the suction component has a fan structure, and a number of the suction component is at least two.

In an embodiment, the precision positioning mechanism further includes telescopic components, the positioning rods are slidably connected to the positioning plate, and the positioning rods are fixedly connected to output ends of the telescopic components respectively.

In an embodiment, the precision positioning mechanism further includes position detection components, the position detection components are configured to detect whether edges of a sheet material abut against the positioning rods, and the position detection components are fixed to sides of the telescopic components respectively.

In a second aspect, the disclosure provides a printing device.

The printing device includes a loading and unloading mechanism, a printing station and a printing unit. The loading and unloading mechanism is configured to control the loading and unloading of a sheet material. The printing station includes at least one printing shifting mechanism and at least one printing platform. The printing platform is fixedly connected to the above-described precision positioning mechanism for sheet materials. The loading and unloading mechanism moves the sheet material onto the printing platform or to remove the sheet material therefrom. The printing unit is configured to perform a printing operation on the sheet material positioned on the printing platform, and the printing shifting mechanism controls the reciprocating movement of the printing platform between the loading and unloading mechanism and the printing unit.

In a third aspect, the disclosure provides a printing process.

The printing process includes the following steps:

step A, moving a sheet material from a loading table to a printing platform by a material shifting mechanism, where the precision positioning mechanism for the sheet materials described above is fixed on the printing platform;

step B, controlling the blowing component to blow air, and detecting in real-time whether the sheet material is moved to a preset position simultaneously; and in response to detecting that the sheet material is moved to the preset position, activating the suction component to pick up the sheet material onto the platform;

step C, performing a printing process on the sheet material on the platform, and after the printing process is completed, removing the sheet material from the platform; and

In summary, compared to the related art, the disclosure has the following beneficial effects.

The precision positioning mechanism for the sheet material provided by the disclosure can control the sheet material to move to the positioning rods through the air blown from the multiple blowing holes, thereby completing a positioning operation of the sheet material. It also fixes the sheet material by drawing the air through the multiple suction holes. Compared to the positioning technologies in the related art, the precision positioning mechanism for the sheet material of the disclosure has advantages including accurate positioning, a simpler structure, and a lower cost.

### BRIEF DESCRIPTION OF DRAWINGS

FIG. 1 illustrates a perspective view of an overall structure of a precision positioning mechanism for sheet materials according to a first embodiment of the disclosure.

FIG. 2 illustrates another perspective view of the overall structure of the precision positioning mechanism for the sheet materials according to the first embodiment of the disclosure.

FIG. 3 illustrates a top view of the precision positioning mechanism for the sheet materials according to the first embodiment of the disclosure.

FIG. 4 illustrates a sectional-cross view of the precision positioning mechanism for the sheet materials taken along a line A-A of FIG. 3.

FIG. 5 illustrates a sectional-cross view of the precision positioning mechanism for the sheet materials taken along a line B-B of FIG. 3.

FIG. 6 illustrates a sectional-cross view of the precision positioning mechanism for the sheet materials taken along a line C-C of FIG. 3.

FIG. 7 illustrates a sectional-cross view of the precision positioning mechanism for the sheet materials taken along a line D-D of FIG. 3.

FIG. 8 illustrates a structural diagram of a printing device according to a second embodiment of the disclosure.

FIG. 9 illustrates a front view of the printing device according to the second embodiment of the disclosure.

FIG. 10 illustrates a top view of the printing device according to the second embodiment of the disclosure.

FIG. 11 illustrates a right-side view of the printing device according to the second embodiment of the disclosure.

FIG. 12 illustrates a schematic diagram of an inner structure of the printing device according to the second embodiment of the disclosure.

FIG. 13 illustrates a schematic diagram of a printing shifting mechanism and a printing platform of the printing device according to the second embodiment of the disclosure.

### DESCRIPTION OF REFERENCE SIGNS

100-platform; 110-positioning plate; 111-blowing hole; 112-suction hole; 113-air collection groove; 114-air conducting hole; 120-base plate; 130-connecting support; 200-blowing component; 300-suction component; 310-fan bracket; 400-telescopic component; 410-positioning rod; 420-guide sleeve; 430-through-hole; 500-position detection component; 600-loading and unloading mechanism; 610-loading table; 620-material shifting mechanism; 630-suction cup mechanism; 640-material conveying mechanism;. 700-printing station; 710-printing shifting mechanism; 720-printing platform; 800-printing unit; 810-printing table shifting mechanism; 820-printing head; 830-printing control unit; 900-housing component; 910-first housing; 920-second housing; 930-third housing; 940-base.

The following will provide a clear and complete description of the technical solutions in the embodiments of the disclosure, combined with the accompanying drawings. Apparently, the described embodiments are only a part of the embodiments of the disclosure, not all of them. Based on the embodiments of the disclosure, all other embodiments obtained by those skilled in the art without creative labor are within the scope of protection of the disclosure.

### First embodiment

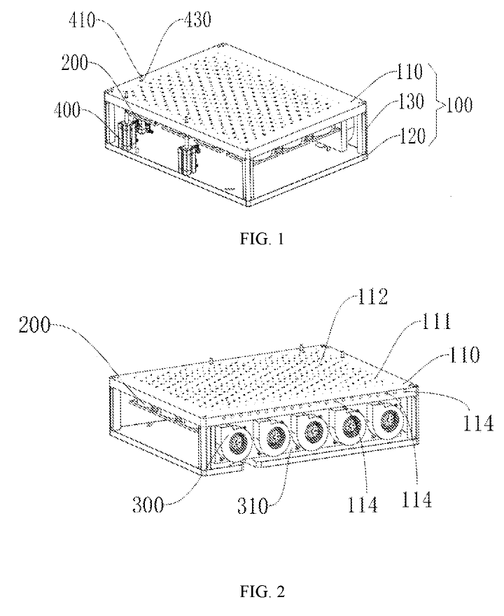

As shown in FIGS. 1-6, the first embodiment of the disclosure provides a precision positioning mechanism for sheet materials. The precision positioning mechanism includes a platform 100, a blowing component 200, a suction component 300 and positioning rods 410. The platform 100 includes a positioning plate 110, and the positioning plate 110 defines multiple blowing holes 111 and multiple suction holes 112, which are distributed uniformly. The positioning rods 410 are securely affixed to two adjacent edges of the positioning plate 110 and protrude from the positioning plate 110 at certain occasion. Each of the multiple blowing holes 111 is inclined with respect to a thickness direction of the positioning plate 110 and is inclined facing towards an intersection point of the two adjacent edges of the positioning plate 110 where the positioning rods 410 are located (i.e., an upward extension direction of each of the multiple blowing holes 111 is at an angle relative to the thickness direction of the positioning plate 110, and it can intersect with an upward extension direction from the intersection point). An air outlet of the blowing component 200 is connected to the multiple blowing holes 111 to blow air into the multiple blowing holes 111, and an air inlet of the suction component 300 is connected to the multiple suction holes 112 to draw air through the multiple suction holes 112.

In the first embodiment, during the positioning process of the precision positioning mechanism, a sheet material, such as a printing paper is placed on the positioning plate 110. The blowing component 200 is activated and blows out the air through the multiple blowing holes 111. Since each of the multiple blowing holes 111 is inclined with respect to the thickness direction of the positioning plate 110, the air blown from the multiple blowing holes 111 causes the sheet material to float and move. Because the positioning rods 410 protrude from the positioning plate 110 and each of the multiple blowing holes 111 is inclined facing towards the intersection point of the two adjacent edges of the positioning plate 110 where the positioning rods 410 are located, the sheet material moves towards the positioning rods 410. Once edges of the sheet material reach the positioning rods 410, the sheet material is blocked by the positioning rod 410, thereby completing the positioning operation. When the sheet material moves to the positioning rods 410, the blowing component 200 is deactivated, and the suction component 300 is activated. The suction component 300 draws the air through the multiple suction holes 112, causing the sheet material to be held against the positioning plate 110, thereby completing precise positioning and fixation of the sheet material.

The precision positioning mechanism for the sheet materials provided in the first embodiment of the disclosure can control the sheet material to move to the positioning rods 410 through the air blown from the multiple blowing holes 111, thereby completing the positioning operation of the sheet material. It also fixes the sheet material by drawing the air through the multiple suction holes 112. Compared to the positioning technologies in the related art, the precision positioning mechanism for the sheet material of the disclosure has advantages including accurate positioning, a simpler structure, and a lower cost.

Specifically, in the first embodiment, as shown in FIG. 1 and FIG. 2, the platform 100 further includes a base plate 120 which is right under the positioning plate 110, and connecting supports 130. The positioning plate 110 has a flat-plate structure. The base plate 120 is arranged parallel to the positioning plate 110. The positioning plate 110 is connected to the base plate 120 through the connecting supports 130. Four connecting supports 130 are provided, and the four connecting rods 130 are located at four corners of the positioning plate 110, respectively. The four connecting rods 130 are fixedly connected to the positioning plate 110 and the base plate 120 through screws.

In the first embodiment, based on the simplicity of processing and the symmetrical layout, the multiple blowing holes 111 and the multiple suction holes 112 are disposed in a row-and-column array, and the multiple blowing holes 111 and the multiple suction holes 112 are alternately arranged.

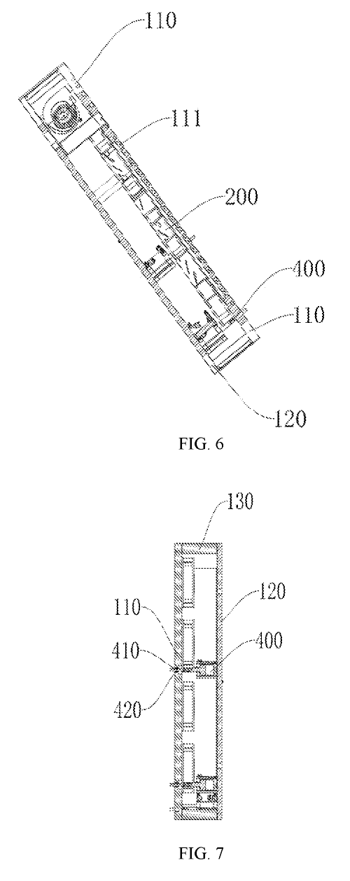

As shown in FIG. 5 and FIG. 6, the blowing component 200 has a fan structure. The blowing component 200 is fixedly connected between the positioning plate 110 and the base plate 120. A surface of the positioning plate 110 facing towards the base plate 120 defines an air collection groove 113, and the air collection groove 113 is square-shaped. A number of the blowing component 200 is at least two, and each of the at least two blowing components 200 is connected to the positioning plate 110 through a plate-shaped bracket structure. The plate-shaped bracket structure defines through-holes configured for breathability. Each of the at least two blowing components 200 is an axial flow fan, which is configured to blow the air toward the air collection groove 113 and subsequently through the multiple blowing holes 111.

In the first embodiment, an air volume of the multiple blowing holes 111 is 20 cubic meters per minute, and the air volume of the multiple blowing holes 111 is adjustable. The air-blowing component 200 adjusts the air volume through a pressure regulating structure or a pulse width modulation (PWM) structure. An axis of each of the multiple blowing holes 111 forms an angle of 40 degrees to 50 degrees with a horizontal plane. By adjusting the blowing intensity of the multiple blowing holes 111, positioning of the sheet material with different thicknesses and weights can be achieved.

It should be noted that in other embodiments, the blowing component 200 can also have a pump structure. In this case, an air outlet of the pump structure is connected to each of the multiple blowing holes 111 through an air tube, or a sealing plate is provided at an opening of the air collection groove 113, and an air outlet of the pump structure is connected to the air collection groove 113 through an air tube.

As shown in FIG. 4, the positioning plate 110 defines multiple air conducting holes 114 arranged in parallel. The multiple air conducting holes 114 are blind holes. The multiple suction holes 112 are connected to the multiple air conducting holes 114. The air inlet of the suction component 300 is connected to ends of the multiple air conducting holes 114. When the suction component 300 is in operation, it draws the air from the multiple suction holes 112 through the multiple air conducting holes 114. The multiple air conducting holes 114 have an opening structure at an edge of the positioning plate 110, and the air inlet of the suction component 300 is fixed to the opening structure of the multiple air conducting holes 114 through methods of screws or adhesion.

In the first embodiment, the suction component 300 has a fan structure. A number of the suction component 300 is at least two, and the at least two fan structures are arranged side by side. The suction component 300 is a turbine fan. The air inlet of the suction component 300 is connected to the ends of the multiple air conducting holes 114 through a tube or a hood structure. When the suction component 300 is in operation, it draws the air through the multiple air conducting holes 114. Each of the at least two suction components 300 is fixedly connected between the positioning plate 110 and the base plate 120 through a fan bracket 310.

In the first embodiment, the suction component 300 can also be an axial flow fan. The fan bracket 310 has a tubular structure, and a side of the fan bracket 310 defines an opening. The ends of the multiple air conducting holes 114 are sealed. A middle of the multiple air conducting holes 114 is connected to the opening of the fan bracket 310. The suction component 300 is connected to the side of the fan bracket 310, and the air inlet of the suction component 300 is connected to the fan bracket 310.

In a specific embodiment, as shown in FIGS. 1,2 and 7, the precision positioning mechanism further includes telescopic components 400. The positioning rods 410 are slidably connected to the positioning plate 110, and the positioning rods 410 are fixedly connected to output ends of the telescopic components 400 respectively. The telescopic components 400 control lifting and lowering of the positioning rods 410, and numbers of both the telescopic components 400 and the positioning rods 410 are at least two. The at least two telescopic components 400 and the at least two positioning rods 410 are distributed along edges where positioning is required, such as edges pointed to by the multiple blowing holes 111.

It should be noted that in the first embodiment, the suction component 300 can also have a pump structure. The air inlet of the suction component 300 is connected to the multiple air conducting holes 114 through an air tube.

In the embodiment, the positioning plate 110 defines through-holes 430. The positioning rods 410 are slidably connected within the through-holes 430 respectively. Outer sides of the positioning rods 410 are provided with guide sleeves 420 respectively, and the guide sleeves 420 are fixed within the through-holes 430 respectively. The telescopic components 400 are fixedly disposed on the base plate 120, and the telescopic components 400 are pneumatic lifting cylinders. The guide sleeves 420 are metal sleeves or rubber sleeves.

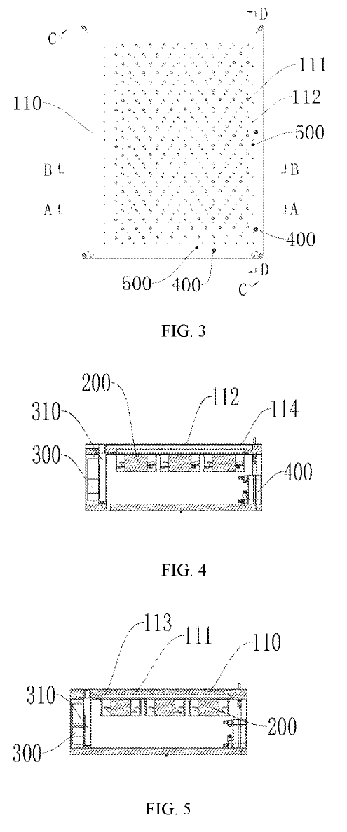

Specifically, in the first embodiment, as shown in FIG. 3, the precision positioning mechanism further includes position detection components 500. The position detection components 500 are configured to detect whether edges of the sheet material abut against the positioning rods 410, thereby determining whether the sheet material is in a preset position.

Specifically, in the first embodiment, detection ends of the position detection components 500 are disposed on sides of the positioning rods 410 respectively, and are located on inner sides of edges formed by the positioning rods 410. When the edges of the sheet material abut against the positioning rods 410, the position detection components 500 generate a change in electric current.

Specifically, in the present embodiment, the position detection components 500 are photoelectric sensors, which are configured to detect changes in light. When the edges of the sheet material abut against the positioning rods 410, the sheet material blocks sensing ends of the photoelectric sensors (i.e., the detection ends of the position detection components 500). If the sensing ends of the photoelectric sensors are unable to receive light or the received light intensity is reduced, it is determined that the edges of the sheet material abut against the positioning rods 410.

It should be noted that the precision positioning mechanism for sheet materials provided by the disclosure is not limited to positioning in printing systems but can also be applied to positioning in other processes, such as applying adhesive, laminating, cutting, and engraving operations on the sheet material in certain processes.

### Second embodiment

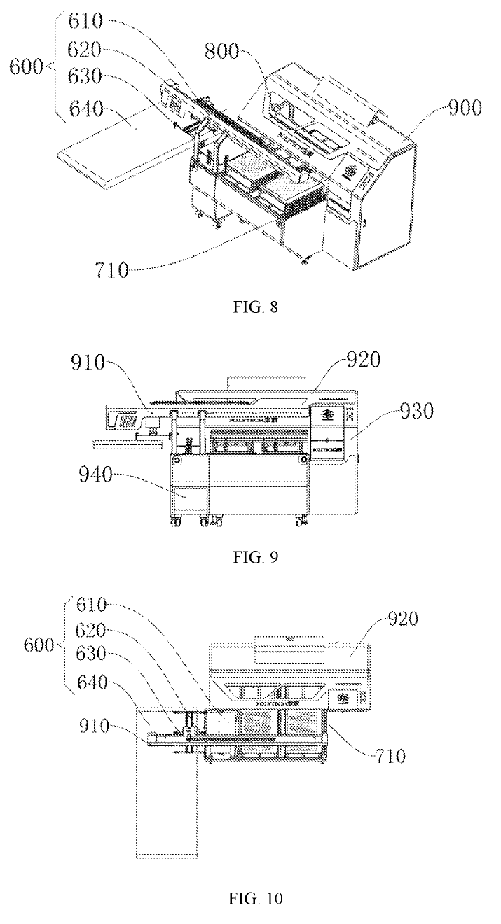

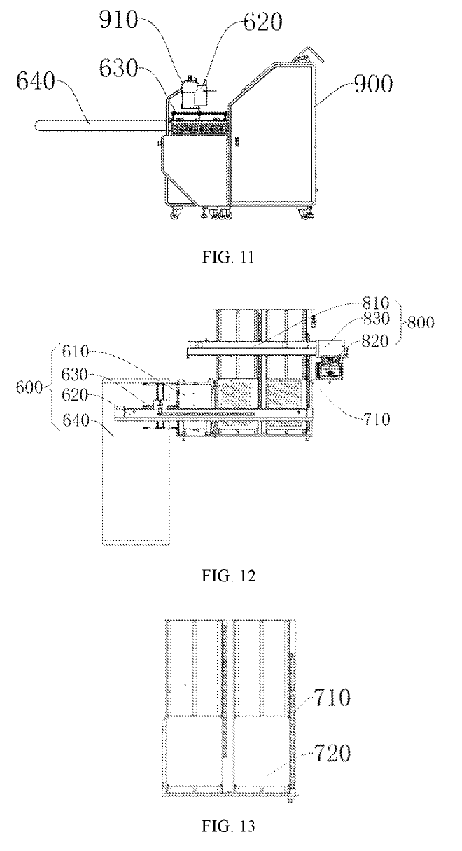

As another embodiment of the disclosure, the second embodiment provides a printing device. As shown in FIGS. 8-13, the printing device includes: a loading and unloading mechanism 600, a printing station 700 and a printing unit 800. The loading and unloading mechanism 600 is configured to control the loading and unloading of a sheet material. The printing station 700 includes at least one printing shifting mechanism 710 and at least one printing platform 720. The printing platform 720 is fixedly connected to the precision positioning mechanism for the sheet materials as described in the first embodiment. The loading and unloading mechanism 600 is configured to move the sheet material onto the printing platform 720 or to remove the sheet material therefrom. The printing unit 800 is configured to perform a print operation on sheet material positioned on the printing platform 720. The printing shifting mechanism 710 is configured to control the printing platform 720 to move reciprocally between the loading and unloading mechanism 600 and the printing unit 800.

Specifically, in the second embodiment, the loading and unloading mechanism 600 includes a loading table 610, a material shifting mechanism 620, a suction cup mechanism 630, and a material conveying mechanism 640. The loading table 610 has a flat plate structure. The material shifting mechanism 620 has a linear shifting structure known in the related art, such as a ball screw linear drive structure. The suction cup mechanism 630 is fixedly connected to an output end of the material shifting mechanism 620, for example, the suction cup mechanism 630 is fixedly connected to screw nuts of the linear drive structure through bolts. The suction cup mechanism 630 is provided with a vacuum nozzle, which is fixed to the output end of the material shifting mechanism 620 through a planar bracket structure. The material shifting mechanism 620 drives the suction cup mechanism 630 to move in a straight line. The suction cup mechanism 630 picks up the sheet material from the loading table 610. The material shifting mechanism 620 can move the sheet material from the loading table 610 to the printing platform 720 through the suction cup mechanism 630. When the sheet material is moved to the printing platform 720, the suction cup mechanism 630 releases the sheet material, allowing it to fall onto the precision positioning mechanism. At this point, the precision positioning mechanism positions and holds the sheet material. The printing shifting mechanism 710 can control the printing platform 720 to move the printing unit 800, and the printing unit 800 performs a printing process on the sheet material held by the precision positioning mechanism to obtain a printed sheet material. After the printing process is completed, the printing shifting mechanism 710 moves the printing platform 720 back to the material shifting mechanism 620. The material shifting mechanism 620 then moves the printed sheet material from the printing platform 720 to the material conveying mechanism 640 through the suction cup mechanism 630. The material conveying mechanism 640, which is a conveyor belt structure known in the related art, can move the printed sheet material to a preset position.

Specifically, in the second embodiment, two printing shifting mechanisms 710 and two printing platforms 720 are provided. The loading and unloading mechanism 600 successively loads the two printing platforms 720, which in turn move to the printing unit 800. For example, when the material shifting mechanism 620 moves the sheet material to the first printing platform 720, the corresponding printing shifting mechanism 710 associated with the first printing platform 720 moves the sheet material to the printing unit 800. Meanwhile, the material shifting mechanism 620 does not cease operation; instead, the loading and unloading mechanism 600 continues to move another sheet material to the second printing platform 720. Once the printing on the sheet material at the first printing platform 720 is completed, the printing shifting mechanism 710 associated with the second printing platform 720 moves the sheet material to the printing unit 800. Meanwhile, the first printing platform 720 that has finished printing moves to the loading and unloading material 600, and the material shifting mechanism 620 moves the printed sheet material to the material conveying mechanism 640 while simultaneously shifting a new sheet material to the first printing platform 720. The two printing platforms 720 alternate in the printing process, thereby enhancing printing efficiency.

In the second embodiment, the printing unit 800 is known in the related art and includes a printing table shifting mechanism 810, a printing head 820, and a printing control unit 830. The printing table shifting mechanism 810 can control the reciprocating movement of the printing control unit 830 to achieve the printing of the sheet material. There is a computer or an industrial control computer, can control the coordinated operation of the material shifting mechanism 620, the suction cup mechanism 630, the printing shifting mechanism 710, and the precision positioning mechanism to accomplish the printing of the sheet material.

In the second embodiment, the printing head 820 may be a digital printing head, a screen-printing squeegee head, a spray head, a dispensing head, a laser marker or cutter, or any other structure capable of performing printing or other processing operations.

Specifically, in the second embodiment, the printing device further includes a housing component 900. The housing component 900 includes a first housing 910, a second housing 920, a third housing 930 and a base 940. The first housing 910 is elongated and is fixedly connected to the material shifting mechanism 620 through screws. The second housing 920 is fixedly connected on the printing unit 800 and the printing shifting mechanism 710. The third housing 930 is fixedly connected to the printing control unit 830. The base 940, which is a box-like structure, is disposed at bottoms of the loading and unloading mechanism 600, the printing station 700, and the printing unit 800 to support the printing device. The loading and unloading mechanism 600, the printing station 700, and the printing unit 800 are fixedly connected to the base 940 through bolts.

In the second embodiment, the printing head 820 is provided with multiple digital printing heads. Through the precision positioning mechanism of the disclosure, it is possible to print different types of inks, such as colored ink, transparent ink, or white ink, either simultaneously or sequentially. The printing unit 800 is capable of printing a single time, multiple times with the same content, or with different contents.

### Third embodiment

As a still another embodiment of the disclosure, the third embodiment provides a printing process. The printing process includes the following steps.

Step A, a sheet material is moved from a loading table 610 to a printing platform 720 by a material shifting mechanism 620, and the printing platform 720 is provided with the precision positioning mechanism for the sheet materials as described in the first embodiment.

Step B, the blowing component 200 is controlled to blow air, and simultaneously, the position detection components 500 are activated to detect in real-time whether the sheet material is moved to a preset position. When the sheet material is detected to be moved to the preset position, the suction component 300 is activated to pick up the sheet material onto the platform 100.

Step C, the sheet material on the platform 100 is performed a printing process, and after the printing process is completed, the sheet material is removed from the platform 100.

Step D, steps A to D are repeated to thereby complete batch printing of the sheet materials.

Specifically, in the third embodiment, a number of the printing platform 720 is at least two. In steps B and C, after loading or unloading the printing platform 720 at a first station is completed, the process continues to load or unload the printing platform 720 at a next station (i.e., a second station). When there is no printing platform 720 that needs loading or unloading, a suction cup mechanism 630 on the material shifting mechanism 620 moves to an origin position.

It should be noted that, in the third embodiment, the material shifting mechanism 620 is provided with the suction cup mechanism 630 to pick up and move the sheet material.

The terminology used in the disclosure is only for the purpose of describing specific embodiments and is not intended to limit the disclosure. The singular forms “a”, “an” and “the” used in the disclosure and the appended claims are also intended to include the plural forms unless the context clearly indicates otherwise. It should also be understood that the term “and/or” used herein refers to and includes any and all possible combinations of one or more of the associated listed items.

It should be understood that although terms such as “first”, “second”, “third” and so on may be used in the disclosure to describe various types of information, these pieces of information should not be limited to these terms. These terms are used merely to distinguish one type of information from another of the same type. For example, without departing from the scope of the disclosure, the first information could also be referred to as the second information, and similarly, the second information could also be referred to as the first information. Depending on the context, the term “if” as used herein may be interpreted as “when”, “upon” or “in response to determining”.

Although the embodiments of the disclosure have been shown and described, it should be understood by those skilled in the art that various changes, modifications, substitutions, and variations can be made to these embodiments without departing from the principles and spirit of the disclosure. The scope of the disclosure is defined by the appended claims and their equivalents.

What is claimed is:

1. A precision positioning mechanism for sheet materials, comprising:
a platform (100), wherein the platform (100) comprises a positioning plate (110), and the positioning plate (110) defines a plurality of blowing holes (111) and a plurality of suction holes (112);
positioning rods (410), wherein the positioning rods (410) are securely affixed to two adjacent edges of the positioning plate (110) and protrude from the positioning plate (110), and each of the plurality of blowing holes (111) is inclined with respect to a thickness direction of the positioning plate (110) and is inclined facing towards an intersection point of the two adjacent edges of the positioning plate (110) where the positioning rods (410) are located; and
a blowing component (200) and a suction component (300), wherein an air outlet of the blowing component (200) is connected to the plurality of blowing holes (111) to blow air into the plurality of blowing holes (111), and an air inlet of the suction component (300) is connected to the plurality of suction holes (112) to draw air through the plurality of suction holes (112).

2. The precision positioning mechanism for the sheet materials as claimed in claim 1, wherein the platform (100) further comprises:
a base plate (120), right under the positioning plate (110), wherein the positioning plate (110) has a flat-plate structure, and the base plate (120) is arranged parallel to the positioning plate (110); and
connecting supports (130), wherein the positioning plate (110) is connected to the base plate (120) through the connecting supports (130).

3. The precision positioning mechanism for the sheet materials as claimed in claim 1, wherein the plurality of blowing holes (111) and the plurality of suction holes (112) are disposed in a row-and-column array.

4. The precision positioning mechanism for the sheet materials as claimed in claim 2, wherein the blowing component (200) has a fan structure and is fixedly connected between the positioning plate (110) and the base plate (120), a surface of the positioning plate (110) facing towards the base plate (120) defines an air collection groove (113), and the air collection groove (113) is square-shaped; and a number of the blowing component (200) is at least two, and each of the at least two blowing components (200) is configured to blow the air toward the air collection groove (113) and subsequently through the plurality of blowing holes (111).

5. The precision positioning mechanism for the sheet materials as claimed in claim 3, wherein the positioning plate (110) defines a plurality of air conducting holes (114), the plurality of air conducting holes (114) are blind holes, the plurality of suction holes (112) are connected to the plurality of air conducting holes (114), and the air inlet of the suction component (300) is connected to ends of the plurality of air conducting holes (114).

6. The precision positioning mechanism for the sheet materials as claimed in claim 5, wherein the suction component (300) has a fan structure, and a number of the suction component (300) is at least two.

7. The precision positioning mechanism for the sheet materials as claimed in claim 1, wherein the precision positioning mechanism further comprises telescopic components (400), the positioning rods (410) are slidably connected to the positioning plate (110), and the positioning rods (410) are fixedly connected to output ends of the telescopic components (400) respectively.

8. The precision positioning mechanism for the sheet materials as claimed in claim 7, wherein the precision positioning mechanism further comprises position detection components (500), the position detection components (500) are configured to detect whether edges of a sheet material abut against the positioning rods (410), and the position detection components (500) are fixed to sides of the telescopic components (400) respectively.

9. A printing device, comprising:
a loading and unloading mechanism (600), configured to control loading and unloading of a sheet material;
a printing station (700), wherein the printing station (700) comprises at least one printing shifting mechanism (710) and at least one printing platform (720), the at least one printing platform (720) is fixedly connected to the precision positioning mechanism for the sheet materials as claimed in claim 1, and the loading and unloading mechanism (600) is configured to move the sheet material onto the at least one printing platform (720) or to remove the sheet material therefrom; and
a printing unit (800), configured to perform a printing operation on the sheet material positioned on the at least one printing platform (720), wherein the at least one printing shifting mechanism (710) is configured to control the at least one printing platform (720) to move reciprocally between the loading and unloading mechanism (600) and the printing unit (800).

10. A printing process, comprising:
step A, moving a sheet material from a loading table (610) to a printing platform (720) by a material shifting mechanism (620), wherein the precision positioning mechanism for the sheet materials as claimed in claim 1 is fixed on the printing platform (720);
step B, controlling the blowing component (200) to blow air, and detecting in real-time whether the sheet material is moved to a preset position simultaneously; and in response to detecting that the sheet material is moved to the preset position, activating the suction component (300) to pick up the sheet material onto the platform (100);
step C, performing a printing process on the sheet material on the platform (100), and after the printing process is completed, removing the sheet material from the platform (100); and
step D, repeating steps A to C to thereby complete batch printing of the sheet materials.
